(19) United States
(12) Patent Application Publication
(10) Pub. No.: US 2026/0231100 A1
(43) Pub. Date: Aug. 6, 2026

(54) METHOD AND APPARATUS FOR SL-PRS TRANSMISSIONS

(71) Applicant: LENOVO (BEIJING) LIMITED, Beijing (CN)

(72) Inventors: Xiaodong Yu, Beijing (CN); Haipeng Lei, Beijing (CN); Zhennian Sun, Beijing (CN); Xin Guo, Beijing (CN)

(21) Appl. No.: 19/154,825

(22) PCT Filed: Feb. 10, 2023
(86) PCT No.: PCT/CN2023/075400

§ 371 Date: Aug. 8, 2025

(51) Int. Cl. H04W 64/00; H04W 72/0446; H04W 72/25

(52) U.S. Cl. CPC H04W 64/00; H04W 72/0446; H04W 72/25

(57) ABSTRACT

Embodiments of the present disclosure relate to methods and apparatuses for sidelink positioning reference signal (SL-PRS) transmissions. According to some embodiments of the disclosure, a user equipment (UE) may include a transceiver; and a processor coupled to the transceiver. The processor may be configured to receive a sidelink control information (SCI) transmission via the transceiver from a another UE, wherein the SCI transmission indicates one or more resources reserved for one or more sidelink positioning reference signal (SL-PRS) sets of the another UE; and determine whether the one or more resources conflict with one or more further resources for one or more other transmissions.

### TECHNICAL FIELD

Embodiments of the present disclosure generally relate to wireless communication technology, especially to methods and apparatuses for sidelink positioning reference signal (SL-PRS) transmissions.

### BACKGROUND

Vehicle to everything (V2X) has been introduced into 3^{rd} Generation Partnership Project (3GPP) 5G wireless communication technology. In terms of a channel structure of V2X communication, a direct link between two UEs is called a sidelink. A sidelink is a long-term evolution (LTE) feature introduced in 3GPP Release 12, and enables a direct communication between proximal UEs, and data does not need to go through a base station (BS) or a core network.

3GPP 5G and/or new radio (NR) networks are expected to increase network throughput, coverage, and robustness and reduce latency and power consumption. With the development of 3GPP 5G and/or NR networks, various aspects need to be studied and developed to perfect the 5G and/or NR technology. Currently, several details regarding SL-PRS transmissions have not been discussed yet.

### SUMMARY

Some embodiments of the present disclosure provide a first user equipment (UE). The first UE may include a transceiver; and a processor coupled to the transceiver. The processor may be configured to receive a sidelink control information (SCI) transmission via the transceiver from a second UE, wherein the SCI transmission indicates one or more first resources reserved for one or more sidelink positioning reference signal (SL-PRS) sets of the second UE; and determine whether the one or more first resources conflict with one or more second resources for one or more other transmissions.

In some embodiments, the processor of the first UE is configured to: in response to determining that the one or more first resources conflict with the one or more second resources, transmit a conflict information indication to indicate a conflict state related to the one or more first resources; or in response to determining that the one or more first resources do not conflict with the one or more second resources: not transmit the conflict information indication; or transmit the conflict information indication to indicate a non-conflict state related to the one or more first resources.

In some embodiments, the SCI transmission indicates at least one of the following: a request for the conflict information indication; the one or more first resources; or UE identity (ID) information.

In some embodiments, the UE ID information belongs to a list of destination IDs, a list of source IDs, or a list of UE IDs for requesting the conflict information indication.

In some embodiments, the processor of the first UE is configured to receive configuration information associated with one or more third resources via the transceiver from a network node or the second UE, and wherein the conflict information indication is transmitted on the one or more third resources.

In some embodiments, the one or more third resources are assigned in each time slot or periodically assigned in one time slot within multiple time slots.

In some embodiments, the one or more first resources and the one or more third resources belong to a SL-PRS resource pool, and wherein the configuration information indicates at least one of the following: a set of symbols of the one or more third resources; a set of sub-channels of the one or more third resources; a set of resource blocks (RB) s of the one or more third resources; a set of resource elements (RE) s of the one or more third resources; a comb size value of the one or more third resources; a resource element (RE) offset value of the one or more third resources; a pattern index value of a SL-PRS pattern associated with the one or more third resources; a comb size value of the SL-PRS pattern; a resource element (RE) offset value of the SL-PRS pattern; a set of RB indices of the one or more third resources, wherein one RB index within the set of RB indices is related to one first resource within the one or more first resources; a time offset value between a time slot carrying the SCI transmission and one or more time slots carrying the one or more third resources; a time offset value between one or more time slots carrying the one or more first resources and the one or more time slots carrying the one or more third resources; a minimum time offset value between the time slot carrying the SCI transmission and the one or more time slots carrying the one or more third resources; a minimum time offset value between the one or more time slots carrying the one or more first resources and the one or more time slots carrying the one or more third resources; or a time period of the multiple time slots associated with the one or more third resources.

In some embodiments, the one or more third resources are assigned in a set of physical sidelink feedback channel (PSFCH) resources in a data resource pool, and wherein the one or more first resources belong to a SL-PRS resource pool associated with the data resource pool.

In some embodiments, the configuration information indicates at least one of the following: the one or more third resources are assigned in the set of PSFCH resources; a time offset value between the SL-PRS resource pool and the data resource pool; a set of time offset values between the one or more first resources and the set of PSFCH resources; or a frequency mapping relationship between the one or more first resources and the set of PSFCH resources.

In some embodiments, the one or more third resources for the conflict information indication are frequency division multiplexed (FDMed) or code division multiplexed (CDMed) with the set of PSFCH resources, wherein at least one of hybrid automatic repeat request-acknowledge (HARQ-ACK) feedback information or a second conflict information indication is transmitted on the set of PSFCH resources, wherein the HARQ-ACK feedback information corresponds to data transmissions in the data resource pool, and wherein the second conflict information indication indicates a conflict state or a non-conflict state related to one or more resources carrying the data transmissions in the data resource pool.

In some embodiments, the conflict information indication includes a set of items, and one item within the set of items indicates a conflict state or a non-conflict state between one first resource within the one or more first resources and the one or more second resources.

In some embodiments, the one item includes: acknowledgement (ACK); negative acknowledgement (NACK); or a SL-PRS sequence.

In some embodiments, the conflict information indication is included in a SCI transmission transmitted by the first UE, and wherein not transmitting the conflict information indication indicates not transmitting the SCI transmission.

Some embodiments of the present application also provide a first UE. The first UE may include a transceiver; and a processor coupled to the transceiver. The processor may be configured to transmit a sidelink control information (SCI) transmission via the transceiver to a second UE, wherein the SCI transmission indicates one or more first resources reserved for one or more sidelink positioning reference signal (SL-PRS) sets of the first UE; and monitor a conflict information indication related to the one or more first resources.

In some embodiments, the SCI transmission indicates at least one of the following: a request for the conflict information indication; the one or more first resources; or UE identity (ID) information.

In some embodiments, the UE ID information belongs to a list of destination IDs, a list of source IDs, or a list of UE IDs for requesting the conflict information indication.

In some embodiments, the processor of the first UE is configured to: receive the conflict information indication via the transceiver from the second UE, determine that the one or more first resources conflict with one or more second resources for one or more transmissions in response to the conflict information indication indicating a conflict state related to the one or more first resources, or determine that the one or more first resources do not conflict with the one or more second resources in response to the conflict information indication indicating a non-conflict state related to the one or more first resources; or determine that the one or more first resources do not conflict with the one or more second resources, in response to not receiving the conflict information indication.

In some embodiments, the processor of the first UE is configured to receive configuration information associated with one or more third resources via the transceiver from a network node or the second UE, and wherein the conflict information indication is received on the one or more third resources.

In some embodiments, the one or more third resources are assigned on each time slot or periodically assigned on one time slot within multiple time slots.

In some embodiments, the one or more first resources and the one or more third resources belong to a SL-PRS resource pool, and wherein the configuration information indicates at least one of the following: a set of symbols of the one or more third resources; a set of sub-channels of the one or more third resources; a set of resource blocks (RB) s of the one or more third resources; a set of resource elements (RE) s of the one or more third resources; a comb size value of the one or more third resources; a resource element (RE) offset value of the one or more third resources; a pattern index value of a SL-PRS pattern associated with the one or more third resources; a comb size value of the SL-PRS pattern; a resource element (RE) offset value of the SL-PRS pattern; a set of RB indices of the one or more third resources, wherein one RB index within the set of RB indices is related to one first resource within the one or more first resources; a time offset value between a time slot carrying the SCI transmission and one or more time slots carrying the one or more third resources; a time offset value between one or more time slots carrying the one or more first resources and the one or more time slots carrying the one or more third resources; a minimum time offset value between the time slot carrying the SCI transmission and the one or more time slots carrying the one or more third resources; a minimum time offset value between the one or more time slots carrying the one or more first resources and the one or more time slots carrying the one or more third resources; or a time period of the multiple time slots associated with the one or more third resources.

In some embodiments, the one or more third resources are assigned in a set of physical sidelink feedback channel (PSFCH) resources in a data resource pool, and wherein the one or more first resources belong to a SL-PRS resource pool associated with the data resource pool.

In some embodiments, the configuration information indicates at least one of the following: the one or more third resources are assigned in the set of PSFCH resources; a time offset between the SL-PRS resource pool and the data resource pool; a set of time offset values between the one or more third resources and the set of PSFCH resources; or a frequency mapping relationship between the one or more third resources and the set of PSFCH resources.

In some embodiments, the one or more third resources for the conflict information indication is frequency division multiplexed (FDMed) or code division multiplexed (CDMed) with the set of PSFCH resources, wherein at least one of hybrid automatic repeat request-acknowledge (HARQ-ACK) feedback information or a second conflict information indication is transmitted on the set of PSFCH resources, wherein the HARQ-ACK feedback information corresponds to data transmissions in the data resource pool, and wherein the second conflict information indication indicates a conflict state or a non-conflict state related to one or more resources carrying the data transmissions in the data resource pool.

In some embodiments, the conflict information indication includes a set of items, and one item within the set of items indicates a conflict state or a non-conflict state between one first resource within the one or more first resources and the one or more second resources.

In some embodiments, the one item includes: acknowledgement (ACK); negative acknowledgement (NACK); or a SL-PRS sequence.

In some embodiments, the conflict information indication is included in a SCI transmission received from the second UE.

Some embodiments of the present disclosure provide a method performed by a first UE. The method may include: receiving a sidelink control information (SCI) transmission from a second UE, wherein the SCI transmission indicates one or more first resources reserved for one or more sidelink positioning reference signal (SL-PRS) sets of the second UE; and determining whether the one or more first resources conflict with one or more second resources for one or more other transmissions.

Some embodiments of the present disclosure provide a method performed by a UE. The method may include: transmitting a sidelink control information (SCI) transmission to a second UE, wherein the SCI transmission indicates one or more first resources reserved for one or more sidelink positioning reference signal (SL-PRS) sets of the first UE; and monitoring a conflict information indication related to the one or more first resources.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method performed by a UE according to some embodiments of the present disclosure.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure.

FIG. 2 illustrates an exemplary flowchart of determining whether resources conflict in accordance with some embodiments of the present disclosure.

FIG. 3 illustrates an exemplary flowchart of monitoring a conflict information indication in accordance with some embodiments of the present disclosure.

FIGS. 4A and 4B illustrate exemplary diagrams of a sidelink slot structure in accordance with some embodiments of the present disclosure.

FIGS. 4C-4E illustrate structures of SL-PRS resource sets in accordance with some embodiments of the present disclosure.

FIGS. 5A-5C illustrate exemplary diagrams regarding conflict information region in accordance with some embodiments of the present disclosure.

FIGS. 6A and 6B illustrate exemplary diagrams regarding conflict information region in accordance with some embodiments of the present disclosure.

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

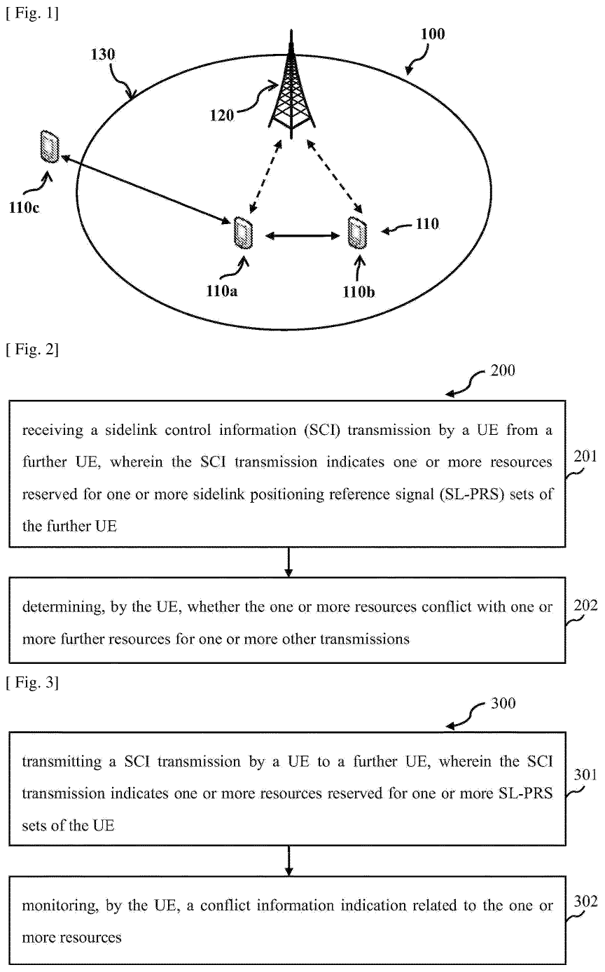

FIG. 1 illustrates a schematic diagram of a wireless communication system in accordance with some embodiments of the present disclosure.

As shown in FIG. 1, a wireless communication system 100 may include a base station (e.g. BS 120) and some UEs 110 (e.g. UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g. UE 110a, UE 110b, or UE 110c) may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g. UE 110a and UE 110b) are within the coverage of BS 120, which may not be the specific BS 120 as shown in FIG. 1 and can be any one of the BSs 120 in a wireless communication system, and some UEs (e.g. UE 110c) are outside of the coverage of BS 120. For example, in the case that the wireless communication system includes two BSs 120 with UE 110a being within the coverage of any one of the two BSs means that UE 110a is within the coverage of a BS 120 (i.e. in-coverage) in the wireless communication system; and UE 110a being outside of the coverage of both BSs 120 means that UE 110a is outside the coverage of a BS 120 (i.e. out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which may be scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

Currently, it is agreed that SL-PRS may be transmitted within a shared resource pool with sidelink (SL) communication or within a dedicated resource pool. Legacy resource allocation and reservation mechanism is used for SL-PRS transmission and resource reservation. A SL-PRS may also be named as “SL PRS” or “a SL-PRS transmission” or the like. However, several issues regarding SL-PRS transmissions need to be solved. Embodiments of the present disclosure provide solutions to solve such issues. For example, some embodiments of the present disclosure define a resource region in a dedicated SL-PRS resource pool for transmitting a conflict information indication in response to a resource collision or conflict related to a SL-PRS transmission/reservation. For instance, the resource region can be a SL-PRS transmission resource. Some embodiments of the present disclosure define (pre-) configuration information of a conflict information indication resource and mapping relationship between a SL-PRS transmission/reservation resource and the conflict information indication resource. Some other embodiments of the present disclosure define a resource region in a data resource pool for transmitting a conflict information indication in response to a resource collision or conflict related to a SL-PRS transmission/reservation. Some embodiments of the present disclosure define an indicator in a SCI transmission transmitted in a dedicated SL-PRS resource pool to indicate a SL-PRS transmission/reservation resource collision or conflict.

In general, inter UE coordination (IUC) scheme 1 and scheme 2 were introduced in Release 17 NR sidelink communication and can be used to indicate a resource selection and reservation collision caused by a hidden node problem and a half duplex issue in NR SL mode 2 resource allocation. In IUC scheme 1, a UE provides a set of preferred or non-preferred resources to another UE by using MAC CE and SCI format 2-C, or MAC CE only. In IUC scheme 2, the reserved resource by a UE is indicated by another UE if a potential resource conflict is detected and the conflict information is carried by PSFCH. In Release 18 SL positioning, for a dedicated resource pool, a PSFCH region may not exist, and PSCCH which carries SCI associated with SL-PRS transmission(s) may be included.

For instance, some embodiments of the present disclosure introduce an autonomous resource selection and relevant resource reservation mechanism of a UE in NR SL for SL-PRS transmission(s). In some embodiments of the present disclosure, e.g. in IUC scheme 2, if a potential resource conflict is detected in a dedicated resource pool, a UE may transmit a conflict information indication related to the resource(s) reserved by another UE and carried by PSFCH in an associated data resource pool. Some embodiments of the present disclosure support IUC scheme 2 in a dedicated resource pool for SL-PRS transmission.

More details on the embodiments of the present disclosure will be illustrated in the following text in combination with the appended drawings.

FIG. 2 illustrates an exemplary flowchart of determining whether resources conflict in accordance with some embodiments of the present disclosure. The exemplary procedure 200 may be performed by a UE, for example, UE 110 in FIG. 1. In some embodiments, the exemplary procedure 200 may be performed by a Tx UE or an Rx UE over sidelink. Although described with respect to a UE, it should be understood that other devices may be configured to perform a method similar to that of FIG. 2.

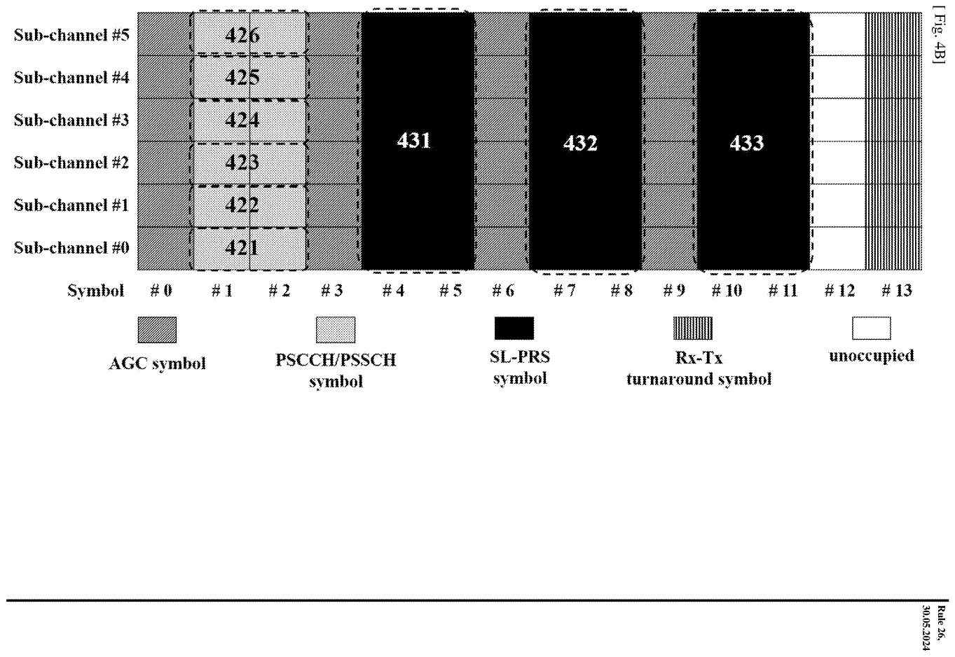

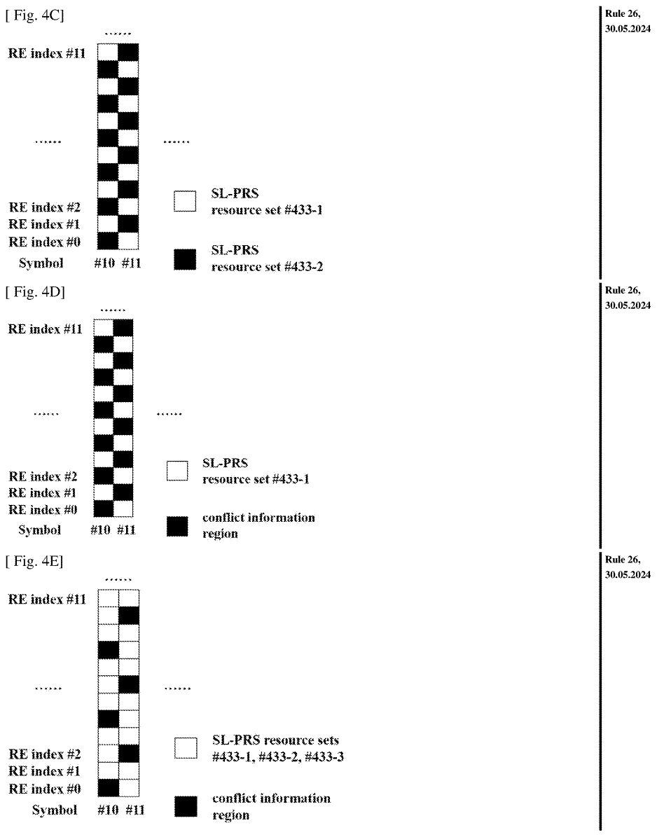

Referring to the exemplary procedure 200 in FIG. 2, in operation 201, a UE (denoted as UE-B for simplicity) (e.g. UE 110a in FIG. 1) may receive a SCI transmission from another UE (denoted as UE-A for simplicity) (e.g. UE 110b in FIG. 1). The SCI transmission indicates one or more resources (denoted as resource(s) #1) reserved for one or more SL-PRS sets of UE-A. For instance, a SL-PRS set may correspond to a SL-PRS pattern associated with a pattern index value. A SL-PRS set may also be named as a SL-PRS resource set or the like. Specific examples of a SL-PRS set are described in the embodiments of FIGS. 4A-4B, e.g. SL-PRS resource sets 431, 432, and 433. Resource(s) #1 reserved for SL-PRS set(s) may also be named as resource(s) #1 reserved for SL-PRS transmission(s) or the like.

In operation 202, UE-B may determine whether resource(s) #1 conflicts with one or more resources (denoted as resource(s) #2) for other transmissions(s). In some embodiments, the other transmission(s) may be potential transmission(s) transmitted to or from UE-B. In some other embodiments, the other transmission(s) may be potential transmission(s) transmitted between other UEs, e.g. transmitted by UE-C to UE-D.

In some embodiments, if resource(s) #1 conflicts with resource(s) #2, UE-B may transmit a conflict information indication to indicate a conflict state related to resource(s) #1. In some other embodiments, if resource(s) #1 does not conflict with resource (s) #2, UE-B may not transmit the conflict information indication, or may transmit the conflict information indication to indicate a non-conflict state related to resource(s) #1.

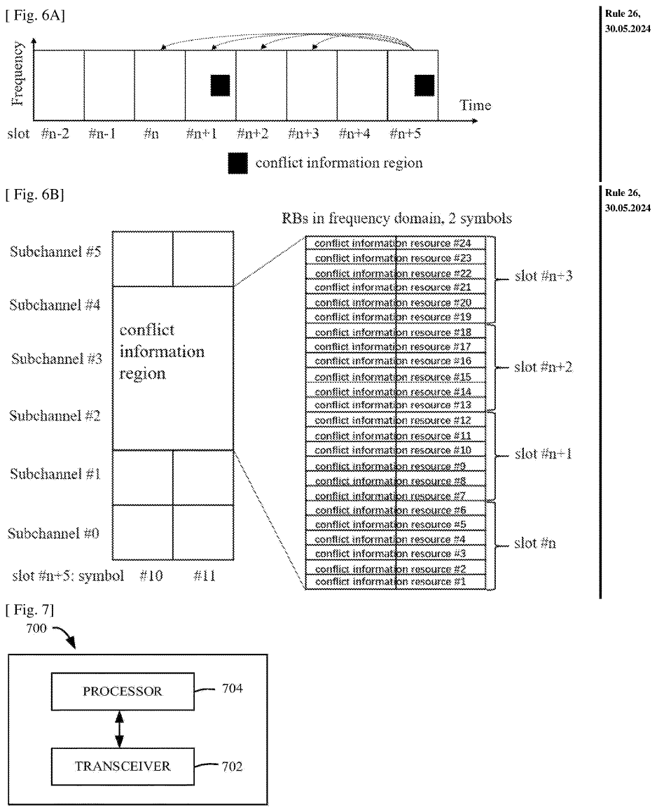

The conflict information indication may also be named as “conflict information”, “conflict related information”, “conflict indicating information”, “non-conflict indicating information”, or the like. For instance, the conflict information indication may indicate both a conflict state and a non-conflict state or indicate a conflict state only. The conflict information indication may be carried in a conflict information resource in a conflict information region, e.g. any of conflict information resources #1 to #24 as shown in the embodiments of FIG. 6B as described below.

Still referring to FIG. 2, in some embodiments, the SCI transmission received in operation 201 indicates at least one of the following:
(1) A request for the conflict information indication. In an embodiment, UE-B may start to determine whether resource(s) #1 conflicts with resource(s) #2, in response to receiving the SCI transmission including the request from UE-A.
(2) Resource(s) #1 which is reserved for SL-PRS set(s). In an embodiment, UE-B may start to determine whether resource(s) #1 conflicts with resource(s) #2, in response to receiving the SCI transmission indicating resource(s) #1 from UE-A.
(3) UE ID information. For instance, the UE ID information may belong to a list of destination IDs, a list of source IDs, or a list of UE IDs for requesting the conflict information indication (e.g. a specific ID list). UE-A and/or UE-B may be configured with the list of destination IDs, the list of source IDs, and/or the specific ID list. In an embodiment, if UE-B determines that the UE ID information indicated by the SCI transmission belongs to the list configured to UE-B, UE-B may start to determine whether resource(s) #1 conflicts with resource(s) #2.

In some embodiments, UE-B may receive (pre-) configuration information (denoted as configuration #1) associated with one or more resources (denoted as resource(s) #3) from a network node (e.g. BS 120 in FIG. 1) or a UE (e.g. UE-A). The conflict information indication may be transmitted on resource(s) #3.

In a specific embodiment, a UE, e.g. UE-A, transmits SCI and the associated SL-PRS transmission in a dedicated resource pool. The SCI can include at least one of: a request for a conflict information indicator, an indicator to indicate one or more resources reserved for SL-PRS transmission(s), UE ID information (e.g. destination ID or source ID or specific ID for requesting the conflict information indicator). If another UE, e.g. UE-B, is configured (pre-) configuration information for a data resource pool or for a dedicated SL-PRS resource pool, or UE-B is enabled for inter-UE coordination (IUC), e.g. enabled inter-UECoordinationScheme2, UE-B can determine, based on the received SCI, a set of resources that includes resource(s) reserved for SL-PRS transmission(s). If UE-B determines a conflict for the resource(s) reserved for SL-PRS transmission(s) (i.e. the reserved resource(s) is overlapped or partial overlapped in time-frequency domain with other potential transmission(s)), UE-B may transmit a conflict information indication e.g. on a (pre-) configured resource. UE-B may determine the request for the conflict information indication which is received from the conflict information target UE e.g. UE-A, based on the UE ID information in the received SCI. For example, if the source ID is indicated or (per-) configured to UE-B, UE-B should determine the request with the indicated or (per-) configured source ID; if the destination ID is indicated or (per-) configured to UE-B, UE-B should determine the request with the indicated or (per-) configured destination ID; or if the specific ID is indicated or (per-) configured to UE-B, UE-B should determine the request with the indicated or (per-) configured specific ID. If UE-B determines a conflict for a resource(s) reserved for SL-PRS transmission(s) and determines that the request is received from the conflict information target UE e.g. UE-A, based on the UE ID information, UE-B may transmit a conflict information indication e.g. on a (pre-) configured resource.

Still referring to FIG. 2, in some embodiments, resource(s) #3 is assigned in each time slot. That is, each time slot includes resource(s) #3 for transmitting the conflict information indication. In some other embodiments, resource(s) #3 is periodically assigned in one time slot within multiple time slots, e.g. every 4 time slots. That is, one time slot within each 4 time slots includes resource(s) #3 for transmitting the conflict information indication. Specific examples are described in the embodiments of FIGS. 6A and 6B as follows.

In some embodiments, resource(s) #1 and resource(s) #3 belong to a SL-PRS resource pool, e.g. a dedicated SL-PRS resource pool. Configuration #1 may indicate at least one of the following:
(1) a set of symbols of resource(s) #3 in time domain;
(2) a set of sub-channels of resource(s) #3 in frequency domain;
(3) a set of RBs of resource(s) #3 in frequency domain;
(4) a set of REs of resource(s) #3 in frequency domain;
(5) a comb size value of resource(s) #3, e.g. comb size=2, 4, or 8;
(6) a RE offset value of resource(s) #3, e.g. RE offset=0 or 1 corresponding to comb size=2, RE offset=0, 2, 3, or 1 corresponding to comb size=4, or RE offset=0, 4, 2, 6, 1, 5, 3, or 7 corresponding to comb size=8;
(7) a pattern index value of a SL-PRS pattern associated with resource(s) #3, e.g. SL-PRS pattern index #0, #1, #2, #3, #4, or #5;
(8) a comb size value of the SL-PRS pattern, e.g. comb size=2, 4, or 8;
(9) a RE offset value of the SL-PRS pattern, e.g. RE offset=0 or 1 corresponding to comb size=2, RE offset=0, 2, 3, or 1 corresponding to comb size=4, or RE offset=0, 4, 2, 6, 1, 5, 3, or 7 corresponding to comb size=8;
(10) a set of RB indices of resource(s) #3, and one RB index within the set of RB indices is related to one resource within resource(s) #1. In some embodiments, the set of RB indices of resource(s) #3 may be an index value or a location value. For instance, according to configuration #1, UE-B may allocate the

$$[ ( i + j \cdot {N}_{SL - PRS}^{P S F C H} ) \cdot {M}_{subch , slot}^{PSFCH} , ( i + 1 + j \cdot {N}_{SL - PRS}^{P S F C H} ) \cdot {M}_{subch , slot}^{PSFCH} - 1 ]$$

PRBs from the

$${M}_{PRB , set}^{PSFCH}$$

PRBs to slot i among the SL-PRS slots associated with the PSFCH slot and sub-channel j, where

$${M}_{subch , slot}^{P S F C H} = {M}_{PRB , set}^{P S F C H} / ( {N}_{subch} \cdot {N}_{SL - PRS}^{P S F C H} ) , 0 \leq i < {N}_{SL - PRS}^{PSFCH} , 0 \leq j < {N}_{s u b c h} ,$$

and the allocation starts in an ascending order of i and continues in an ascending order of j. UE-B may expect that

$${M}_{PRB , set}^{P S F C H}$$

is a multiple of

$${N}_{subch} \cdot {N}_{SL - PRS}^{P S F C H} .$$

(11) a time offset value between a time slot carrying the SCI transmission or the associated SL-PRS transmission and time slot(s) with resource(s) #3, for example, when resource(s) #3 is assigned in each time slot; and this time offset value can be a logic time slot offset value or a physical time slot offset value;
(12) a time offset value between time slot(s) with resource(s) #1 and the time slot(s) with resource(s) #3, for example, when resource(s) #3 is assigned in each time slot; and this time offset value can be a logic time slot offset value or a physical time slot offset value;
(13) a minimum time offset value between the time slot carrying the SCI transmission or the associated SL-PRS transmission and the time slot(s) with resource(s) #3, for example, when resource(s) #3 is periodically assigned in one time slot within multiple time slots, e.g. every 2, 4, or 8 time slots; and this minimum time offset value can be a logic time slot offset value or a physical time slot offset value;
(14) a minimum time offset value between the time slot(s) with resource(s) #1 and the time slot(s) with resource(s) #3, for example, when resource(s) #3 is periodically assigned in one time slot within multiple time slots, e.g. every 2, 4, or 8 time slots; and this minimum time offset value can be a logic time slot offset value or a physical time slot offset value; or
(15) a time period of the multiple time slots associated with resource(s) #3. For instance, the time period of the multiple time slots may be per one time slot or per every 2, 4 or 8 time slots.

In some embodiments, resource(s) #3 is assigned in a set of PSFCH resources in a data resource pool, and resource(s) #1 belongs to a SL-PRS resource pool associated with the data resource pool, e.g. a dedicated SL-PRS resource pool. That is, resource(s) #3 and resource(s) #1 belong to different resource pools. In an embodiment, configuration #1 indicates at least one of the following:
(1) Resource(s) #3 is assigned in the set of PSFCH resources, e.g. in a data resource pool with PSFCH resource(s).
(2) A time offset value between the SL-PRS resource pool and the data resource pool, e.g. a logic time slot offset value or a physical time slot offset value.
(3) A time domain mapping relationship between resource(s) #3 and the set of PSFCH resources, e.g. a set of time slot offset values between resource(s) #3 and the set of PSFCH resources.
(4) A frequency mapping relationship between resource(s) #3 and the set of PSFCH resources, e.g. a set of frequency offset values or a set of mapping equations between resource(s) #3 and the set of PSFCH resources.
(5) A set of frequency offset values between the staring frequency RB index of resource(s) #3 and the staring frequency (lowest) RB index of the set of PSFCH resources.

For instance, in a specific embodiment, a UE, e.g. UE-B, can be provided by sl-PRS-Conflict-RB-Set a set of

$${M}_{PRB , set}^{PSFCH}$$

physical resource blocks (PRB) s in a resource pool for PSFCH transmission(s) with a conflict information indication in a PRB of a dedicated SL-PRS resource pool. The UE can be enabled, by inter-UECoordinationScheme2, to transmit a PSFCH with the conflict information indication in a resource pool. The UE can determine, based on an indication by a SCI format 1-A, a set of resources that includes one or more time slots and resource blocks that are reserved for PSSCH transmission(s). If the UE determines a conflict for resource(s) reserved for PSSCH transmission(s), the UE may provide the conflict information indication in a PSFCH.

In another specific embodiment, a UE, e.g. UE-B, may be provided by sl-PSFCH-RB-Set a set of

$${M}_{PRB , set}^{PSFCH}$$

PRBs in a resource pool for PSFCH transmission(s) with HARQ-ACK feedback information in a PRB of a resource pool. The UE can be provided by sl-PSFCH-Conflict-RB-Set a set of

$${M}_{PRB , set}^{PSFCH}$$

PRBs in a resource pool for PSFCH transmission(s) with conflict information in a PRB of the resource pool. The UE expects that different PRBs are (pre-) configured for conflict information indication(s) and HARQ-ACK feedback information. For a number of N_{subch} sub-channels for the resource pool, provided by sl-NumSubchannel, and a number of PSSCH slots associated with a PSFCH slot that is less than or equal to

$${N}_{SL - PRS}^{P SFCH} ,$$

according to configuration #1, the UE may allocate the

$$[ ( i + j \cdot {N}_{SL - PRS}^{P S F C H} ) \cdot {M}_{subch , slot}^{PSFCH} , ( i + 1 + j \cdot {N}_{SL - PRS}^{P S F C H} ) \cdot {M}_{subch , slot}^{PSFCH} - 1 ]$$

PRBs from the

$${M}_{PRB , set}^{P S F C H}$$

PRBs to slot i among the SL-PRS slots associated with the PSFCH slot and sub-channel j, where

$${M}_{subch , slot}^{P S F C H} = {M}_{PRB , set}^{P S F C H} / ( {N}_{subch} \cdot {N}_{SL - PRS}^{P S F C H} ) , 0 \leq i < {N}_{SL - PRS}^{PSFCH} ,$$

0≤j<N_{subch}, and the allocation start in an ascending order of i and continues in an ascending order of j. The UE expects that

$${M}_{PRB , set}^{PSFCH}$$

is a multiple of

$${N}_{s u b c h} \cdot {N}_{SL - PRS}^{P S F C H} .$$

In some embodiments, resource(s) #3 for the conflict information indication related to resource(s) #1 may be FDMed or CDMed with the set of PSFCH resources in the data resource pool. HARQ-ACK feedback information and/or a further conflict information indication may be transmitted on the set of PSFCH resources. The HARQ-ACK feedback information may correspond to data transmission(s) in the data resource pool. The further conflict information indication may be related to resource(s) carrying the data transmission(s) in the data resource pool.

In some embodiments, the conflict information indication includes a set of items. An item within the set of items may indicate a conflict state or a non-conflict state between one resource within resource(s) #1 and resource(s) #2. For instance, the item may include ACK, NACK, or a SL-PRS sequence. The conflict information indication may be a sequence, which is a sequence including both ACK and NACK, a sequence including ACK only, a sequence including NACK only, or a SL-PRS sequence. In an embodiment, ACK indicates that resource(s) #1 conflicts with resource(s) #2, and NACK indicates that resource(s) #1 does not conflict with resource(s) #2. In another embodiment, ACK indicates that resource(s) #1 does not conflict with resource(s) #2, and NACK indicates that resource(s) #1 conflicts with resource(s) #2. For instance, there may be two SL-PRS sequences to represent two states of the conflict information indication, i.e. a conflict state and a non-conflict state. In an embodiment, the SL-PRS sequence may be 10101 or 00011, “10101” indicates that resource(s) #1 does not conflict with resource(s) #2, and “00011” indicates that resource(s) #1 conflicts with resource(s) #2. In another embodiment, the SL-PRS sequence “10101” indicates that resource(s) #1 conflicts with resource(s) #2, and “00011” indicates that resource(s) #1 does not conflict with resource(s) #2.

For example, after UE-B determines a conflict for a reserved resource for SL-PRS transmission, UE-B transmits a conflict information indication on (pre-) configured resource(s) or UE-B transmits a sequence with the meaning of “conflict” on the (pre-) configured resource(s). After UE-B does not determine a conflict for a reserved resource for SL-PRS transmission, UE-B does not perform a transmission on the (pre-) configured resource(s) or UE-B transmits a sequence with the meaning of “non-conflict” on the (pre-) configured resource(s).

In some embodiments, the conflict information indication may be included in a SCI transmission transmitted by UE-B. In some embodiments, UE-B not transmitting the conflict information indication indicates UE-B not transmitting the SCI transmission. For instance, after UE-B determines a conflict for resource(s) reserved for SL-PRS transmission(s), UE-B may transmit a SCI transmission including a conflict information indicator with “conflict” state (e.g. set to “1”). After UE-B does not determine a conflict between the resource(s) reserved for SL-PRS transmission(s) and other potential transmission(s), e.g. during a certain time period, UE-B may transmit a SCI transmission including a conflict information indicator with “non-conflict” state (e.g. set to “0”) or UE-B may not transmit a SCI transmission with a conflict information indication. UE-B not transmitting a SCI transmission with conflict information indication may represent that there is no conflict for resource(s) reserved for SL-PRS transmission(s).

Details described in all other embodiments of the present disclosure are applicable for the embodiments shown in FIG. 2. It should be appreciated by persons skilled in the art that the sequence of the operations in the exemplary procedure 200 as shown in FIG. 2 may be changed and some of the operations in the exemplary procedure 200 may be eliminated or modified, without departing from the spirit and scope of the disclosure.

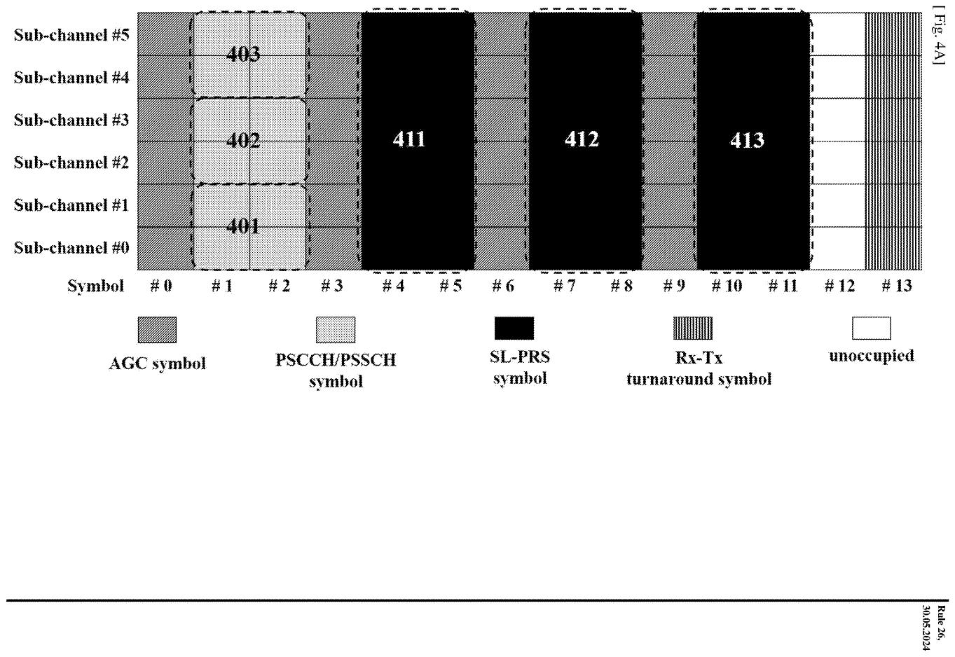

FIG. 3 illustrates an exemplary flowchart of monitoring a conflict information indication in accordance with some embodiments of the present disclosure. The exemplary procedure 300 may be performed by a UE, for example, UE 110 in FIG. 1. In some embodiments, the exemplary procedure 300 may be performed by a Tx UE or an Rx UE over sidelink. Although described with respect to a UE, it should be understood that other devices may be configured to perform a method similar to that of FIG. 3.

Referring to the exemplary procedure 300 in FIG. 3, in operation 301, a UE (e.g. UE 110b in FIG. 1) (e.g. UE-A as described in FIG. 2) may transmit a SCI transmission to a further UE (e.g. UE-B as described in FIG. 2). The SCI transmission indicates one or more resources (e.g. resource(s) #1 as described in FIG. 2) reserved for one or more SL-PRS sets of the UE. In operation 302, the UE may monitor a conflict information indication related to resource(s) #1.

In some embodiments, the SCI transmission indicates at least one of the following: (1) a request for the conflict information indication; (2) resource(s) #1 reserved for SL-PRS set(s); or (3) UE ID information. In an embodiment, the UE ID information belongs to a list of destination IDs, a list of source IDs, or a list of UE IDs for requesting the conflict information indication (e.g. a specific ID list).

In some embodiments, the UE may receive the conflict information indication from the further UE. If the conflict information indication indicates a conflict state related to resource(s) #1, the UE may determine that resource(s) #1 conflicts with one or more resources (e.g. resource(s) #2 as described in FIG. 2) for one or more transmissions. If the conflict information indication indicates a non-conflict state related to resource(s) #1, the UE may determine that resource(s) #1 does not conflict with resource(s) #2. In response to not receiving the conflict information indication, the UE may determine that resource(s) #1 does not conflict with resource(s) #2.

In some embodiments, the UE may receive configuration information (e.g. configuration #1 as described in FIG. 2) associated with one or more resources (e.g. resource(s) #3 as described in FIG. 2), on which the conflict information indication is received, from a network node or a UE e.g. the further UE. In some embodiments, resource(s) #3 is assigned on each time slot or periodically assigned on one time slot within multiple time slots, e.g. every 2, 4, or 8 time slots.

In some embodiments, resource(s) #1 and resource(s) #3 belong to a SL-PRS resource pool, e.g. a dedicated SL-PRS resource pool, and configuration #1 indicates at least one of the following:
(1) a set of symbols of resource(s) #3 in time domain;
(2) a set of sub-channels of resource(s) #3 in frequency domain;
(3) a set of RBs of resource(s) #3 in frequency domain;
(4) a set of REs of resource(s) #3 in frequency domain;
(5) a comb size value of resource(s) #3, e.g. comb size=2, 4, or 8;
(6) a RE offset value of resource(s) #3, e.g. RE offset=0 or 1 corresponding to comb size=2, RE offset=0, 2, 3, or 1 corresponding to comb size=4, or RE offset=0, 4, 2, 6, 1, 5, 3, or 7 corresponding to comb size=8;
(7) a pattern index value of a SL-PRS pattern associated with resource(s) #3, e.g. SL-PRS pattern index #0, #1, #2, #3, #4, or #5;
(8) a comb size value of the SL-PRS pattern, e.g. comb size=2, 4, or 8;
(9) a RE offset value of the SL-PRS pattern, e.g. RE offset=0 or 1 corresponding to comb size=2, RE offset=0, 2, 3, or 1 corresponding to comb size=4, or RE offset=0, 4, 2, 6, 1, 5, 3, or 7 corresponding to comb size=8;
(10) a set of RB indices of resource(s) #3, wherein one RB index within the set of RB indices is related to one resource within resource(s) #1;
(11) a time offset value between a time slot carrying the SCI transmission or the associated SL-PRS transmission and one or more time slots with resource(s) #3, for example, when resource(s) #3 is assigned in each time slot; and this time offset value can be a logic time slot offset value or a physical time slot offset value;
(12) a time offset value between one or more time slots with resource(s) #1 and the one or more time slots with resource(s) #3, for example, when resource(s) #3 is assigned in each time slot; and this time offset value can be a logic time slot offset value or a physical time slot offset value;
(13) a minimum time offset value between the time slot carrying the SCI transmission or the associated SL-PRS transmission and the one or more time slots with resource(s) #3, for example, when resource(s) #3 is periodically assigned in one time slot within multiple time slots, e.g. every 2, 4, or 8 time slots; and this minimum time offset value can be a logic time slot offset value or a physical time slot offset value;
(14) a minimum time offset value between the one or more time slots with resource(s) #1 and the one or more time slots with resource(s) #3, for example, when resource(s) #3 is periodically assigned in one time slot within multiple time slots, e.g. every 2, 4, or 8 time slots; and this minimum time offset value can be a logic time slot offset value or a physical time slot offset value; or
(15) a time period of the multiple time slots associated with resource(s) #3. For instance, the time period of the multiple time slots may be per one time slot or per every 2, 4 or 8 time slots.

In some embodiments, resource(s) #3 is assigned in a set of PSFCH resources in a data resource pool, and resource(s) #1 belongs to a SL-PRS resource pool associated with the data resource pool. In an embodiment, configuration #1 indicates at least one of the following:
(1) resource(s) #3 is assigned in the set of PSFCH resources, e.g. in a data resource pool with PSFCH resource(s);
(2) a time offset between the SL-PRS resource pool and the data resource pool, e.g. a logic time slot offset value or a physical time slot offset value;
(3) a set of time offset values between resource(s) #3 and the set of PSFCH resources, e.g. a set of time slot offset values between resource(s) #3 and the set of PSFCH resources;
(4) a frequency mapping relationship between resource(s) #3 and the set of PSFCH resources, e.g. a set of frequency offset values or a set of mapping equations between resource(s) #3 and the set of PSFCH resources; or
(5) a set of frequency offset values between the staring frequency RB index of resource(s) #3 and the staring frequency (lowest) RB index of the set of PSFCH resources.

In some embodiments, resource(s) #3 for the conflict information indication are FDMed or CDMed with the set of PSFCH resources in the data resource pool. HARQ-ACK feedback information and/or a further conflict information indication may be transmitted on the set of PSFCH resources. The HARQ-ACK feedback information corresponds to data transmission(s) in the data resource pool. The further conflict information indication indicates a conflict state or a non-conflict state related to resource(s) carrying the data transmission(s) in the data resource pool.

In some embodiments, the conflict information indication includes a set of items. An item within the set of items indicates a conflict state or a non-conflict state between one resource within resource(s) #1 and resource(s) #2. In some embodiments, the item includes ACK; NACK; or a SL-PRS sequence (e.g. “0000” represents a conflict state, and “1111” represents a non-conflict state).

In some embodiments, the conflict information indication is included in a SCI transmission received from the further UE.

Details described in all other embodiments of the present disclosure are applicable for the embodiments shown in FIG. 3. It should be appreciated by persons skilled in the art that the sequence of the operations in the exemplary procedure 300 as shown in FIG. 3 may be changed and some of the operations in the exemplary procedure 300 may be eliminated or modified, without departing from the spirit and scope of the disclosure.

The following texts describe specific embodiments of the exemplary procedure 200 or 300 in FIG. 2 or FIG. 3 performed by a UE, i.e. in FIGS. 4A-6B. Details described in all other embodiments of the present application are applicable for the embodiments of any of FIGS. 4A-6B. Moreover, details described in the embodiments of any of FIGS. 4A-6B are applicable for all the embodiments of FIGS. 1-3 and 7.

In some embodiments of the present disclosure, a conflict information region is configured in a dedicated SL-PRS resource pool. A conflict information region may be named as “a set of resources for conflict information transmission” or “a set of conflict information resources” or the like. The conflict information region may include conflict information resource(s) and may carry conflict information indication(s).

The conflict information region can be a set of (pre-) configuration resources for SL-PRS transmission in a dedicated SL-PRS resource pool, i.e. it can be configured or enabled per resource pool. A network or a UE, e.g. UE-A, may transmit (pre-) configuration information to another UE, e.g. UE-B, to indicate a conflict information region in a dedicated SL-PRS resource pool including resource(s) reserved for SL-PRS transmission(s). In the conflict information region, each conflict information transmission is assigned within a certain time domain resource and a certain frequency domain resource. The time domain resource can be one or more symbols of (pre-) configuration resource(s) for SL-PRS transmission(s), e.g. 2 symbols. The frequency domain resource can be one or more RBs and in comb-based manner. For instance, as shown in FIG. 4A, each PSCCH and/or PSSCH region (e.g. including a PSCCH region only case) has its associated SL-PRS transmission region. In each SL-PRS transmission region, the SL-PRS transmission resource is assigned in comb-based manner.

FIGS. 4A and 4B illustrate exemplary diagrams of a sidelink slot structure in accordance with some embodiments of the present disclosure. FIGS. 4C-4E illustrate structures of SL-PRS resource sets in accordance with some embodiments of the present disclosure. In FIGS. 4A and 4B, there are 14 symbols in one time slot, which are marked by #0, #1, #2, #3, #4, #5, #6, #7, #8, #9, #10, #11, #12, and #13, respectively. For instance, there are 6 sub-channels in frequency domain, which are marked by sub-channel #0, sub-channel #1, sub-channel #2, sub-channel #3, sub-channel #4, and sub-channel #5 respectively.

In some embodiments of the present disclosure, each SCI region includes one or more SCI transmissions, which may include a PSCCH resource, a PSSCH resource, or both PSCCH and PSSCH resources. Each SCI transmission may occupy a SCI resource set. A SCI resource set may also be named as “a SCI transmission resource set” or the like. Accordingly, the SCI region includes a number of SCI resource sets for a set of SCI transmissions. For instance, in the embodiments of FIG. 4A, SCI region 401 includes sub-channel #0 and sub-channel #1 and symbol #1 and symbol #2 for SCI transmission. SCI region 402 includes sub-channel #2 and sub-channel #3 and symbol #1 and symbol #2 for SCI transmission. SCI region 403 includes sub-channel #4 and sub-channel #5 and symbol #1 and symbol #2 for SCI transmission.

Each SCI region in FIG. 4A includes two SCI resource sets, and details are shown in FIG. 4B. There are two SCI transmissions in SCI region 401, and the SCI resource sets are FDMed in SCI region 401. As can be seen, SCI transmission resource 421 and SCI transmission resource 422 in FIG. 4B are FDMed in SCI region 401 in FIG. 4A. Similarly, SCI transmission resource 423 and SCI transmission resource 424 in FIG. 4B are FDMed in SCI region 402 in FIG. 4A. SCI transmission resource 425 and SCI transmission resource 426 in FIG. 4B are FDMed in SCI region 403 in FIG. 4A. That is, SCI resource sets in SCI regions 401, 402, and 403 in FIG. 4A can be FDMed by 6 UEs in total as shown in FIG. 4B.

In some embodiments of the present disclosure, each SL-PRS region includes one or more SL-PRS transmissions. For instance, in the embodiments of FIG. 4A, SL-PRS region 411 includes sub-channel #0 to sub-channel #5 on symbol #4 and symbol #5 for SL-PRS transmission(s). SL-PRS region 412 includes sub-channel #0 to sub-channel #5 on symbol #7 and symbol #8 for SL-PRS transmission(s). SL-PRS region 413 includes sub-channel #0 to sub-channel #5 on symbol #10 and symbol #11 for SL-PRS transmission(s).

In each SL-PRS region in FIG. 4A, multiple SL-PRS resource sets may be assigned with the same comb size and different RE offset values, i.e. multiple SL-PRS resource sets in each SL-PRS region are orthogonal in time and frequency domains. For example, in FIGS. 4A and 4B, for SL-PRS resource set(s) on symbol #4 and symbol #5, the comb size is 2. For SL-PRS resource set(s) on symbol #7 and symbol #8, the comb size is 2. For SL-PRS resource set(s) on symbol #10 and symbol #11, the comb size is 2. The set of comb sizes may include {2, 2, 2}. In FIGS. 4C and 4D, for SL-PRS resource set(s) on symbol #10 and symbol #11, the comb size is 2. In FIG. 4E, for SL-PRS resource set(s) on symbol #10 and symbol #11, the comb size is 4.

For instance, in the SL-PRS regions in FIG. 4A, there may be two potential PSCCH/PSSCH resource associated SL-PRS resources, and details are shown in FIG. 4B. In FIG. 4B, SL-PRS resource set 431 includes two potential PSCCH/PSSCH resources #1 and #2 associated SL-PRS resources, SL-PRS resource set 432 includes two potential PSCCH/PSSCH resources #3 and #4 associated SL-PRS resources, and SL-PRS resource set 433 includes two potential PSCCH/PSSCH resources #5 and #6 associated SL-PRS resources. Although only one comb size, e.g. 2, is illustrated in FIGS. 4A-4C, other values of comb sizes and other values of symbols may also be applied when appropriate.

A set of RE offset values may be applied for SL-PRS resource set(s). For example, in FIGS. 4A-4C, for SL-PRS resource set(s) on symbol #4 and symbol #5, the set of RE offset is {0, 1}. For SL-PRS resource set(s) on symbol #7 and symbol #8, the set of RE offset is {0, 1}. For SL-PRS resource set(s) on symbol #10 and symbol #11, the set of RE offset is {0, 1}. Other set of RE offset values of the SL-PRS set(s) may also be applied when appropriate.

For example, the resources in symbol #12 from sub-channel #0 to sub-channel #5 in FIGS. 4A and 4B are unoccupied.

FIGS. 4C-4E illustrate structures of SL-PRS resource sets #433-1, #433-2, and/or #433-3, on two symbols in time domain and one RB in a sub-channel in frequency domain (e.g. SL-PRS resource sets within SL-PRS resource set 433 as shown in FIG. 4B). One RB includes 12 REs, which are marked by RE index #0, RE index #1, RE index #2, . . . , and RE index #11.

In SL-PRS resource set 433, assuming that the total number of SL-PRS symbols is 2 and the comb size is 2, for each RB on symbol #10 and symbol #11 and sub-channel #0 to sub-channel #5, with SL-PRS RE offset=0, a UE (e.g. UE 110a in FIG. 1) may determine SL-PRS resource set #433-1 including REs which are shown as white blocks in FIG. 4C. Accordingly, the UE may transmit the SCI on SCI transmission resource 421 in FIG. 4B, to indicate the associated SL-PRS transmission on SL-PRS resource set #433-1 for each RB in SL-PRS resource set 433. A further UE (e.g. UE 110b in FIG. 1) may determine SL-PRS resource set #433-2 including REs which are shown as blocks of dashed lines in FIG. 4C. The further UE may transmit the SCI on SCI transmission resource 422, to indicate the associated SL-PRS transmission on SL-PRS resource set #432-2 for each RB in SL-PRS resource set 433.

Similar to FIG. 4C, assuming that the comb size is 2 in FIG. 4D, SL-PRS resource set #433-1 in FIG. 4D includes REs which are shown as white blocks. Different from FIG. 4C, REs shown as blocks of dashed lines in FIG. 4D constitute a conflict information region and may be used for transmitting conflict information indication(s) as described in the embodiments of FIGS. 2 and 3.

Different from FIGS. 4C and 4D, assuming that the comb size is 4 in FIG. 4E, SL-PRS resource sets #433-1 #433-2, and #433-3 in FIG. 4E include REs shown as white blocks, and REs shown as blocks of dashed lines in FIG. 4E constitute a conflict information region and may be used for transmitting conflict information indication(s) as described in the embodiments of FIGS. 2 and 3.

For instance, in the embodiments of FIGS. 4D, (pre-) configuration information may indicate a conflict information region in a dedicated SL-PRS resource pool in following different specific embodiments.

In an embodiment, the (pre-) configuration information may indicate a conflict information region within symbol #10 to #11 and sub-channel #0 to #5 to use resources with RE offset=0 (in blocks of dashed lines) in comb size=2. In a further embodiment, the (pre-) configuration information may indicate a conflict information region within symbol #10 to #11 and RB index #20 to #60 to use resources with RE offset=0 (in blocks of dashed lines) in comb size=2.

In another embodiment, the (pre-) configuration information may indicate that the resource for each conflict information indication within symbol #10 to #11 to occupy one RB, i.e. REs with indices #0, #2, #4, #6, #8, #10 on symbol #10 and REs with indices #1, #3, #5, #7, #9, and #11 on symbol #11.

In an additional embodiment, the (pre-) configuration information may indicate that a time frequency resource of a conflict information indication is set to a certain (pre-) configured SL-PRS pattern index which is associated with a (pre-) configured SL-PRS pattern as shown in FIG. 4A. For example, assuming that SL-PRS pattern indices #0, #1, #2, #3, #4, and #5 are configured to the embodiments of FIG. 4A, the (pre-) configuration information may indicate that a (pre-) configured SL-PRS pattern with SL-PRS pattern index #2 is used as the conflict information region. That is, the conflict information resource is assigned on symbol #6 and symbol #7 in time domain and with the RE offset value {0}, i.e. REs with indices #0, #2, #4, #6, #8, #10 on symbol #6 and REs with indices #1, #3, #5, #7, #9, and #11 on symbol #7.

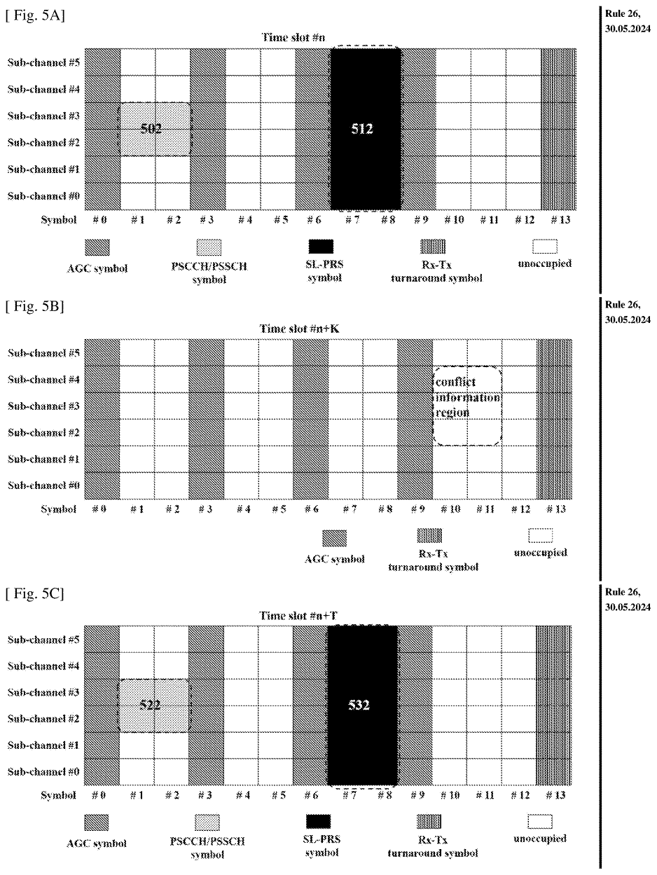

In yet an additional embodiment, the (pre-) configuration information may indicate a time domain mapping relationship between a SCI or SL-PRS transmission resource and a conflict information region or indicate a time domain mapping relationship between a resource reserved for SL-PRS transmission and the conflict information region, as shown in FIGS. 5A-5C, 6A, and 6B.

FIGS. 5A-5C illustrate exemplary diagrams regarding conflict information region in accordance with some embodiments of the present disclosure. The configurations of time-frequency resources and locations of data region(s), control region(s), AGC symbol(s), and Rx/Tx turnaround symbol(s) in the time-frequency resources in the embodiments of FIGS. 5A-5C are similar to those in FIGS. 4A-4E.

As shown in FIGS. 5A-5C, a SCI transmission is transmitted in SCI region 502 and SL-PRS transmission is transmitted in SL-PRS region 512 at time slot #n. The SCI transmission in SCI region 502 reserves a resource for a SCI transmission in SCI region 522 and/or a resource for SL-PRS transmission in SL-PRS region 532 at time slot #n+T. A conflict information region may be assigned at a time slot between time slot #n and time slot #n+T. In an example, a time gap between the SCI transmission and the conflict information region may be (pre-) configured or fixed as “K” after time slot #n, and thus the conflict information region is assigned at time slot #n+K as shown in FIG. 5B. In another example, a time gap between the resource reserved by the SCI transmission and the conflict information region may be (pre-) configured or fixed as “K” before time slot #n+T, and thus the conflict information region is assigned at time slot #n+T-K (not shown in the drawings).

In yet an additional embodiment, the (pre-) configuration information can indicate a time period of a set of conflict information resources, e.g. the conflict information region is assigned per one time slot, or every 4 time slots (specific embodiments are described in FIGS. 6A and 6B). The conflict information region on each time slot may be used to carry conflict information related to one or more time slots. For instance, if the conflict information region is assigned per one time slot, the (pre-) configuration information can indicate a time offset value, i.e. a time domain mapping relationship between a SCI transmission resource and the conflict information region, or a time domain mapping relationship between a resource reserved for a SL-PRS transmission and the conflict information region.

FIGS. 6A and 6B illustrate exemplary diagrams regarding conflict information region in accordance with some embodiments of the present disclosure. The configurations of time-frequency resources and locations of data region(s), control region(s), AGC symbol(s), and Rx/Tx turnaround symbol(s) in the time-frequency resources in the embodiments of FIGS. 6A and 6B are similar to those in FIGS. 4A-4E.

As shown in FIG. 6A, conflict information regions are assigned every 4 time slots, e.g. in time slot #n+1 and time slot #n+5. For instance, the conflict information region in time slot #n+1 may carry conflict information resources related to time slot #n−4 (not shown in FIG. 6A) to time slot #n−1. The conflict information region in time slot #n+5 may carry conflict information resources related to time slot #n to time slot #n+3. A conflict information resource may also be named as “a conflict resource” or “a conflict time-frequency resource” or “a conflict set” or the like.

The (pre-) configuration information may indicate conflict information frequency resource(s) corresponding to SL-PRS transmission(s)/reservations(s) on one or more time slots. The frequency resource of conflict information resource(s) for SL-PRS transmission(s)/reservations(s) on time slot #n may be mapped from the lowest RB(s) or the lowest RB set; the frequency resource of conflict information resource(s) for SL-PRS transmission(s)/reservations(s) on time slot #n+1 may be mapped to the second lowest one or more RB(s) or the second lowest RB set; and so on.

As shown in FIG. 6B, the conflict information region in time slot #n+5 within 2 symbols, i.e. symbols #10 and #11, include multiple RBs in the frequency domain, e.g. conflict information resources #1 to #24. Conflict information resources #1 to #6 may be used for carrying conflict information indication(s) for time slot #n, conflict information resources #7 to #12 may be used for carrying conflict information indication(s) for time slot #n+1, conflict information resources #13 to #18 may be used for carrying conflict information indication(s) for time slot #n+2, and conflict information resources #19 to #24 may be used for carrying conflict information indication(s) for time slot #n+3.

For example, the frequency resource of conflict information indication(s) for SL-PRS transmission #1 and its reserved resource on time slot #n is assigned on the lowest RB in the conflict information region, i.e. conflict information resource #1; the frequency resource of conflict information indication(s) for the SL-PRS transmission #2 and its reserved resource on time slot #n is assigned on the second lowest RB in the conflict information region, i.e. conflict information resource #2; and so on. Other conflict information resources for any of time slots #n to #n+3 may be in a similar manner.

It should be appreciated by persons skilled in the art that the above detailed values are only exemplary, and the detailed configuration values in the sidelink slot structure or in the conflict information region, e.g. the total number of time-frequency resources and locations of data region(s), control region(s), AGC symbol(s), and Rx/Tx turnaround symbol(s) in the time-frequency resources as shown in FIGS. 4A-6B, may be changed, varied, or modified in different embodiments, without departing from the spirit and scope of the disclosure.

FIG. 7 illustrates a block diagram of an exemplary apparatus in accordance with some embodiments of the present disclosure. As shown in FIG. 7, the apparatus 700 may include at least one processor 704 and at least one transceiver 702 coupled to the processor 704. Although in this figure, elements such as the at least one transceiver 702 and processor 704 are described in the singular, the plural is contemplated unless a limitation to the singular is explicitly stated. In some embodiments of the subject application, the transceiver 702 may be divided into two devices, such as a receiving circuitry and a transmitting circuitry. In some embodiments of the subject application, the apparatus 700 may further include an input device, a memory, and/or other components.

In some embodiments of the subject application, the apparatus 700 may be a UE or a network node (e.g. a BS). The transceiver 702 and the processor 704 may interact with each other so as to perform the operations with respect to the UE or the network node described above, for example, in any of FIGS. 1-6B.

In some embodiments of the subject application, the apparatus 700 may further include at least one non-transitory computer-readable medium. For example, in some embodiments of the present disclosure, the non-transitory computer-readable medium may have stored thereon computer-executable instructions to cause the processor 704 to implement the method with respect to a UE or a network node (e.g. a BS) as described above. For example, the computer-executable instructions, when executed, cause the processor 704 interacting with transceiver 702 to perform the operations with respect to the UE or the network node described in FIGS. 1-6B.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A first user equipment (UE), comprising:
at least one memory; and
at least one processor coupled with the at least one memory and configured to cause the first UE to:
receive a sidelink control information (SCI) transmission via the transceiver from a second UE, wherein the SCI transmission indicates one or more first resources reserved for one or more sidelink positioning reference signal (SL-PRS) sets of the second UE; and
determine whether the one or more first resources conflict with one or more second resources for one or more other transmissions.

2. The first UE of claim 1, wherein the at least one processor is configured to cause the first UE to:
in response to determining that the one or more first resources conflict with the one or more second resources, transmit a conflict information indication to indicate a conflict state related to the one or more first resources; or
in response to determining that the one or more first resources do not conflict with the one or more second resources:
not transmit the conflict information indication; or
transmit the conflict information indication to indicate a non-conflict state related to the one or more first resources.

3. The first UE of claim 2, wherein the SCI transmission indicates at least one of the following:
a request for the conflict information indication;
the one or more first resources; or
UE identity (ID) information.

4. The first UE of claim 3, wherein the UE ID information belongs to a list of destination IDs, a list of source IDs, or a list of UE IDs for requesting the conflict information indication.

5. The first UE of claim 2, wherein the at least one processor is configured to cause the first UE to receive configuration information associated with one or more third resources from a network node or the second UE, and wherein the conflict information indication is transmitted on the one or more third resources.

6. The first UE of claim 5, wherein the one or more third resources are assigned in each time slot or periodically assigned in one time slot within multiple time slots.

7. The first UE of claim 5, wherein the one or more first resources and the one or more third resources belong to a SL-PRS resource pool, and wherein the configuration information indicates at least one of the following:
a set of symbols of the one or more third resources;
a set of sub-channels of the one or more third resources;
a set of resource blocks (RB) s of the one or more third resources;
a set of resource elements (RE) s of the one or more third resources;
a comb size value of the one or more third resources;
a resource element (RE) offset value of the one or more third resources;
a pattern index value of a SL-PRS pattern associated with the one or more third resources;
a comb size value of the SL-PRS pattern;
a resource element (RE) offset value of the SL-PRS pattern;
a set of RB indices of the one or more third resources, wherein one RB index within the set of RB indices is related to one first resource within the one or more first resources;
a time offset value between a time slot carrying the SCI transmission and one or more time slots carrying the one or more third resources;
a time offset value between one or more time slots carrying the one or more first resources and the one or more time slots carrying the one or more third resources;
a minimum time offset value between the time slot carrying the SCI transmission and the one or more time slots carrying the one or more third resources;
a minimum time offset value between the one or more time slots carrying the one or more first resources and the one or more time slots carrying the one or more third resources; or
a time period of multiple time slots associated with the one or more third resources.

8. The first UE of claim 5, wherein the one or more third resources are assigned in a set of physical sidelink feedback channel (PSFCH) resources in a data resource pool, and wherein the one or more first resources belong to a SL-PRS resource pool associated with the data resource pool.

9. The first UE of claim 8, wherein the configuration information indicates at least one of the following:
the one or more third resources are assigned in the set of PSFCH resources;
a time offset value between the SL-PRS resource pool and the data resource pool;
a set of time offset values between the one or more first resources and the set of PSFCH resources; or
a frequency mapping relationship between the one or more first resources and the set of PSFCH resources.

10. The first UE of claim 8, wherein the one or more third resources for the conflict information indication are frequency division multiplexed (FDMed) or code division multiplexed (CDMed) with the set of PSFCH resources, wherein at least one of hybrid automatic repeat request-acknowledge (HARQ-ACK) feedback information or a second conflict information indication is transmitted on the set of PSFCH resources, wherein the HARQ-ACK feedback information corresponds to data transmissions in the data resource pool, and wherein the second conflict information indication indicates a conflict state or a non-conflict state related to one or more resources carrying the data transmissions in the data resource pool.

11. The first UE of claim 2, wherein the conflict information indication includes a set of items, and one item within the set of items indicates a conflict state or a non-conflict state between one first resource within the one or more first resources and the one or more second resources.

12. The first UE of claim 2, wherein the conflict information indication is included in a SCI transmission transmitted by the first UE, and wherein not transmitting the conflict information indication indicates not transmitting the SCI transmission.

13. A first user equipment (UE), comprising:
at least one memory; and
at least one processor coupled with the at least one memory and configured to cause the first UE to:
transmit a sidelink control information (SCI) transmission to a second UE, wherein the SCI transmission indicates one or more first resources reserved for one or more sidelink positioning reference signal (SL-PRS) sets of the first UE; and
monitor a conflict information indication related to the one or more first resources.

14. The first UE of claim 13, wherein the at least one processor is configured to cause the first UE to:
receive the conflict information indication from the second UE:
determine that the one or more first resources conflict with one or more second resources for one or more transmissions, in response to the conflict information indication indicating a conflict state related to the one or more first resources; or
determine that the one or more first resources do not conflict with the one or more second resources, in response to the conflict information indication indicating a non-conflict state related to the one or more first resources; or
determine that the one or more first resources do not conflict with the one or more second resources, in response to not receiving the conflict information indication.

15. A method performed by a first user equipment (UE), the method comprising:
receiving a sidelink control information (SCI) transmission from a second UE, wherein the SCI transmission indicates one or more first resources reserved for one or more sidelink positioning reference signal (SL-PRS) sets of the second UE; and
determining whether the one or more first resources conflict with one or more second resources for one or more other transmissions.

16. A processor for wireless communication, comprising:
at least one controller coupled with at least one memory and configured to cause the processor to:
receive a sidelink control information (SCI) transmission from a second user equipment (UE), wherein the SCI transmission indicates one or more first resources reserved for one or more sidelink positioning reference signal (SL-PRS) sets of the second UE; and
determine whether the one or more first resources conflict with one or more second resources for one or more other transmissions.

17. The processor of claim 16, wherein the at least one controller is configured to cause the processor to:
in response to determining that the one or more first resources conflict with the one or more second resources, transmit a conflict information indication to indicate a conflict state related to the one or more first resources; or
in response to determining that the one or more first resources do not conflict with the one or more second resources:
not transmit the conflict information indication; or
transmit the conflict information indication to indicate a non-conflict state related to the one or more first resources.

18. The processor of claim 17, wherein the SCI transmission indicates at least one of the following:
a request for the conflict information indication;
the one or more first resources; or
UE identity (ID) information.

19. The processor of claim 18, wherein the UE ID information belongs to a list of destination IDs, a list of source IDs, or a list of UE IDs for requesting the conflict information indication.

20. The processor of claim 17, wherein the at least one controller is configured to cause the processor to receive configuration information associated with one or more third resources from a network node or the second UE, and wherein the conflict information indication is transmitted on the one or more third resources.
